(19) United States
(12) Patent Application Publication
(10) Pub. No.: US 2026/0322909 A1
(43) Pub. Date: Oct. 15, 2026

(54) Cell phone mounting system

(71) Applicant: Andrae D'Acquisto, Bellevue, IA (US)

(72) Inventor: Andrae D'Acquisto, Bellevue, IA (US)

(21) Appl. No.: 18/831,551

(22) Filed: Apr. 15, 2025

(51) Int. Cl. H04M 1/04; F16M 11/04; F16M 11/10; F16M 11/20; F16M 13/02

(52) U.S. Cl. CPC H04M 1/04; F16M 11/041; F16M 11/10; F16M 11/2014; F16M 13/02

(57) ABSTRACT

The invention relates to a cell phone mount for affixing a cell phone to a support structure such as a camera arm, archery bow, bike or ATV/UTV handlebars and the like. The mount comprises
a linear central support comprising at least two hooked jaws configured to cradle said cell phone wherein at least one of said laws is slidably adjustable to secure the vertical or horizontal length of said cell phone;
an adjustment arm for adjusting the aim point of the cell phone mount; and
a support base attached to said linear central support, said support base configured to secure said mount to a support structure, wherein said support base permits the rotational movement of said phone mount on both the vertical and horizontal axis.

### FIELD OF THE INVENTION

The present invention relates to a cell phone mounting system for attaching a cell phone to a camera arm, archery bow, firearm and the like for filming or taking photos.

### BACKGROUND OF THE INVENTION

As the video and photographic capabilities of cell phones have advanced, their use in filming and photo applications has skyrocketed. In outdoor applications, as an example, use of a cell phone is much more convenient and practical that conventional photo or video equipment. A cell phone is smaller and lighter than conventional filming equipment and allows you to instantaneously view photos and/or video footage and send same to remote users effortlessly through email or text messages. And there is little if any loss of photo quality.

The cell phone mounting system of the invention is compact, lightweight, has fewer moving parts and is adaptable for use with various support structures including but not limited to camera arms, tripods, archery bows, firearms, bicycle handlebars and the like.

### SUMMARY OF THE INVENTION

The present invention relates to a compact cell phone mount for affixing a cell phone to a support structure such as a camera arm, archery bow and the like without the use of cumbersome of extension arms, or ball and socket elements. The mount of the invention comprises a linear central support structure comprising integrated means for holding a cell phone in either the vertical or horizontal position; an adjustment arm for adjusting the aim point of the cell phone mount; and a support base for attaching the linear central support of the mount to a support structure.

### BRIEF DESCRIPTION OF THE DRAWINGS

FIG. 1 shows a side view of the cell phone mount in accordance with the invention.

FIG. 2 shows an alternative side view of the cell phone mount of the invention.

FIG. 3 shows a top side view of the cell phone mount in accordance with the invention.

FIG. 4 shows the cell phone mount of the invention with the adjustment arm in the folded position.

FIG. 5 shows an alternative top side view of the cell phone mount of the invention.

FIG. 6 is a back side view of the mount of the invention showing the adjustability of the mount and the tension dial screw.

FIGS. 7 and 8 show the front view of the pad eye plate component of the cell phone mount of the invention.

FIG. 9 is a side view of the pad eye plate component of the cell mount of the invention.

FIG. 10 depicts the machined slot and side walls of the linear central support of the mount of the invention.

FIG. 11 depicts a side view of the mount of the invention where the pad eye plate is being inserted into the machined slot of the linear central support of the present cell phone mount.

FIG. 12 shows a top view of the mounting plate of the support base of the mount of the invention.

FIG. 13 shows a cell phone cradled in the mount of the invention.

FIG. 14 shows a cell phone in the mount of the invention affixed to the riser of an archery bow.

FIG. 15 shows the mount of the invention affixed to the riser of an archery bow in a folded-up position.

FIG. 16 shows the mount of the invention affixed to the riser of an archery bow in a folded-down position.

FIG. 17 depicts a back view of a cell phone cradled in the mount of the invention affixed to a camera arm.

FIG. 17 FIG. 18 depicts a front view of a cell phone cradled in the mount of the invention affixed to a camera arm.

### DETAILED DESCRIPTION OF THE INVENTION

The present invention relates to a lightweight and compact cell phone mount for affixing a cell phone to a support structure such as a camera arm, archery bow and the like. The mount of the invention comprises a linear central support structure comprising integrated means for holding a cell phone in either the vertical or horizontal position; an optional adjustment arm for adjusting the aim point of the cell phone mount; and a support base for attaching the linear central support of the mount to a support structure.

Designed for maximum functionality, durability and ease of use, the ultra-compact phone mount system of the invention eliminates the need for bulky fluid heads, ball in socket fixtures, magnets and other cumbersome setups. Weighing approximately 3 ounces and measuring approximately 4.5 inches by ⅝ inches wide, the phone mount system of the invention offers unmatched portability while retaining rock solid stability. Its dual axis movement allows for smooth, precise adjustments ensuring a perfectly framed shot in any environment. Designed for universal compatibility, the mount of the invention securely holds all phone sizes and integrates seamlessly with various camera arms, archery bows, and the like creating the lightest and lowest profile setup in the industry. The deployable adjustment arm enables effortless setup, while rugged machined billet construction guarantees rugged durability.

The cell phone mount (1) of the invention comprises a linear central support structure (2) i.e., the central support is straight with no angles and has the ability to pivot on two axis on its support base (3), providing unparalleled flexibility to frame your shots. The linear support structure (2) comprises at least two hooked jaws or brackets (4) configured to cradle and secure cell phone or other mobile device wherein at least one of said laws is slidably adjustable to secure the vertical or horizontal length of said cell phone. The second jaw or bracket is non-slidable or fixed as it is formed from and is one piece with the linear central support. Once the slidable jaw is adjusted to firmly secure the cell phone in either the vertical or horizontal orientation, it is secured in place by means of a tension dial screw (5) that allows for the quick and easy securement of the moveable jaw such that it securely holds the cell phone in place.

The linear central support (2) also comprises an adjustment arm (6) that allows the user to easily and conveniently adjust the positioning and aim point of the cell phone mount. In one embodiment the adjustment arm (6) is centrally positioned and affixed to said linear central support (2). By being centrally located, as opposed to being off to the left or right side of said support it is more easily accessible by the user and less likely to interfere when filming.

The claimed mount also comprises a versatile support base (3) attached to said linear central support (2), said support base configured to permit the rotation or adjustment of the phone mount on two axis or planes, in another embodiment on both the vertical and horizontal axis, without the need for additional accessories such as a tripod ball mount. The support base (3) comprises a pad eye plate (7) and a mounting plate (8) secured to said central support (2) by fastening means such as one or more of a screw, bolt and nut, pin or stud. The support base (3) is also configured to secure the phone mount (1) to a support structure such as a camera arm, or archery bow and the like.

As previously mentioned, the support base (3) comprises a mounting plate (8) and a pad eye plate (7). The pad eye plate (7) comprises a horizontal base (9), a vertical wall (10) with a mounting hole (11) located on the upper surface of said horizontal base (9) that is substantially perpendicular to said horizontal base (9), and a threaded bolt portion (12) extending down on the underside of said horizontal base (9) opposite the vertical wall (10).

On the bottom surface of said pad eye plate (7) below the horizontal base (9) and opposite the vertical wall (10) of the pad eye plate (7) the pad eye plate (7) comprises a threaded bolt appendage (12) which is adapted to screw into a camera arm, or an accessary mounting hole of an archery bow. A longer threaded appendage (12) or bolt may be needed for mounting to an archery bow accessory hole of an archery bow. The linear central support (2) comprises a machined slot (13) having side walls (14) with mounting holes (15) wherein said slot is configured to receive the vertical wall (10) of said pad eye plate (7). The mounting holes of the side walls (15) of the machined slot (13) are configured to align with the mounting hole (11) of the vertical wall (10) of said pad eye plate (7). The pad eye plate (7) is inserted into said machined slot (13) and the mounting hole (11) of the vertical wall (10) or plate of the pad eye plate (7) is aligned with the mounting holes (15) of the side walls (14) of said machined slot (13) and secured to said central support (2) by fastening means inserted through the aligned mounting holes.

The base of said pad eye plate (7) is attached to the mounting plate (8) and permits the rotational movement of said center support on horizontal axis while the vertical wall (10) of said pad eye plate (7) permits the movement of said mount forward and backward on the vertical axis. The mounting plate (8) of said support base (3) comprises mounting holes (17) on each end and is secured to said linear center support by means of the pad eye plate (7). More specifically, the threaded bolt or appendage (12) of said pad eye plate (7) is inserted though mounting hole on one end of the mounting plate and secured with a threaded bolt and lock nut (17). The mounting hole on the opposite end of said mounting plate (8) is configured to be attached to a support structure such as a camera arm or archery bow. The mounting plate (8) is generally flat, or it can be curved provided that it does not place the mount/cell phone in an awkward position for filming. In one embodiment the mounting plate (8) is substantially perpendicular to the vertical plane of the linear central support.

The term “fastening means” as used herein can be virtually any means that can secure two structures together including but not limited to a threaded bolt and nut, non-threaded bolt, pin, screw, bracket and the like.

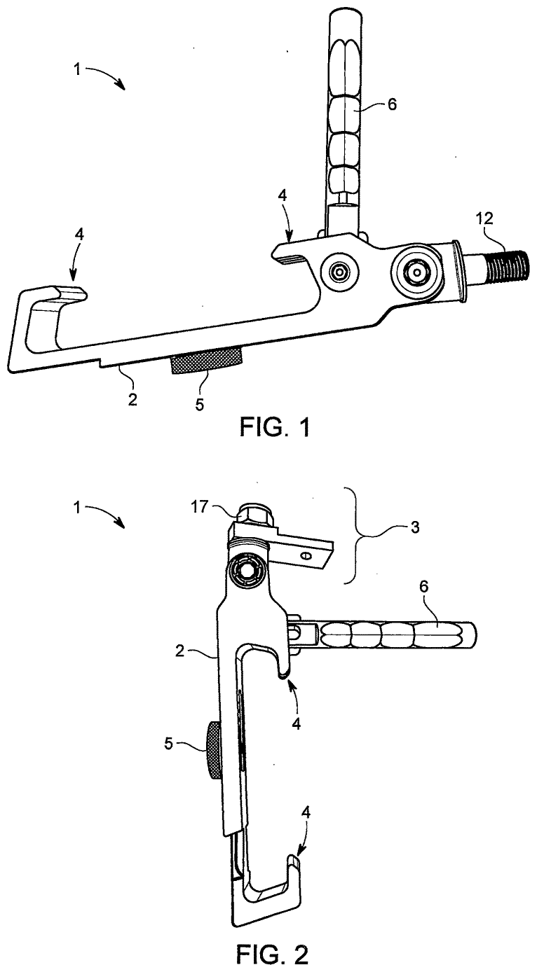

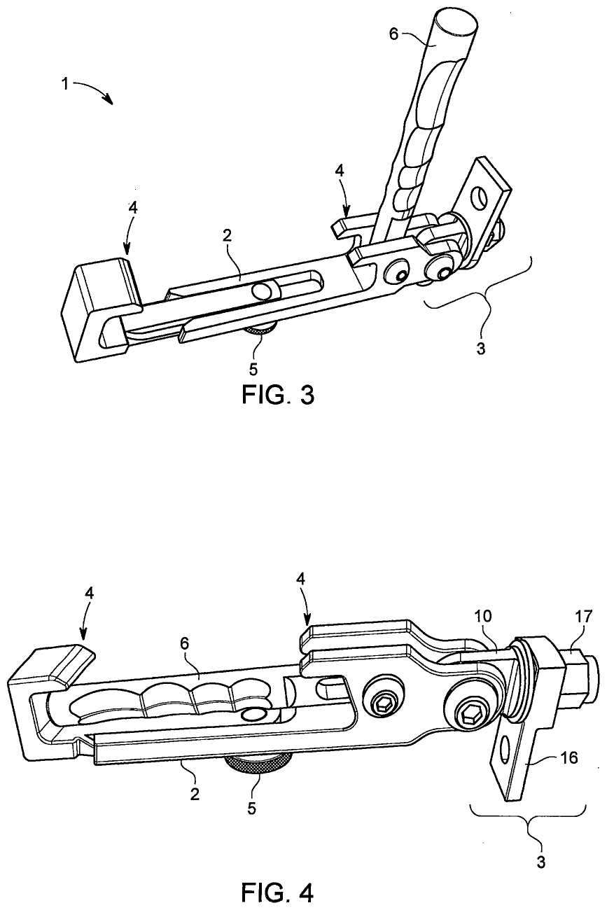

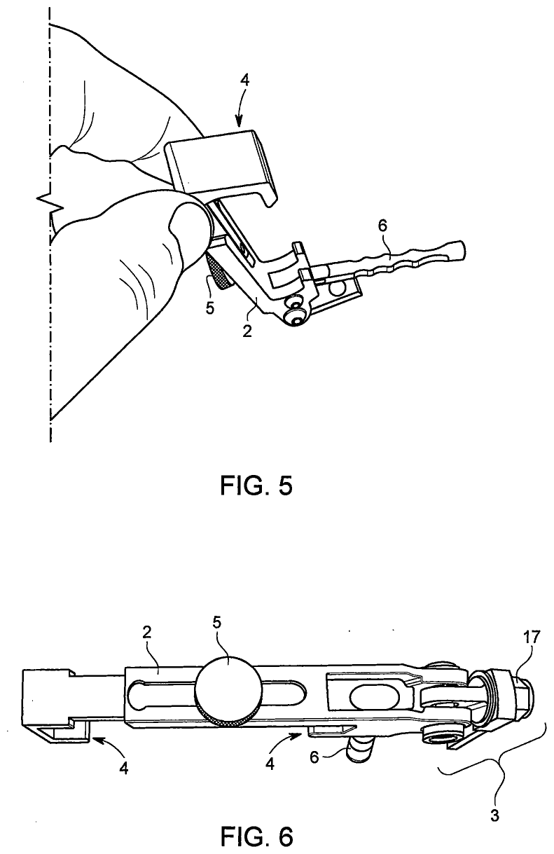

FIGS. 1-6 show various views of the cell phone mount (1) of the invention. FIGS. 3 and 6 depict how the movable jaw is slidable allowing adjustment of the mount to fit various cell phone sizes.

As shown in FIG. 4, the phone mount (1) of the invention is collapsible and designed to fold into itself staying securely on your camera arm or bow when not in use. In the collapsed mode the adjustment arm (6) is configured to fold into and lay flat on the linear central support (2).

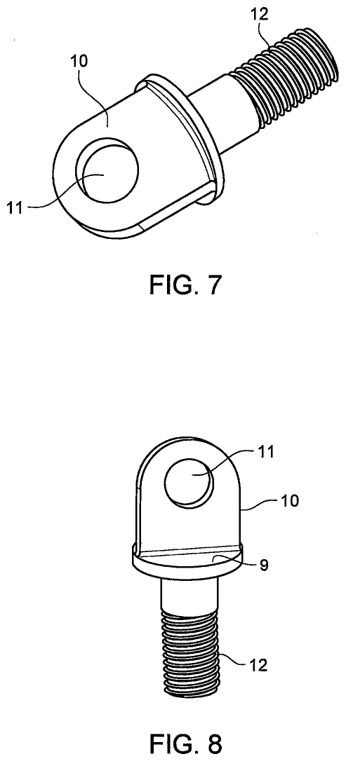

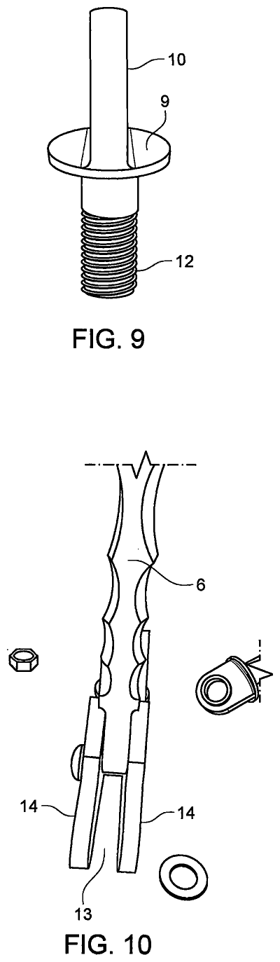

FIG. 7-9 show various views of the pad eye plate (7), while FIG. 12 shows the mounting plate (8) of the support base (3).

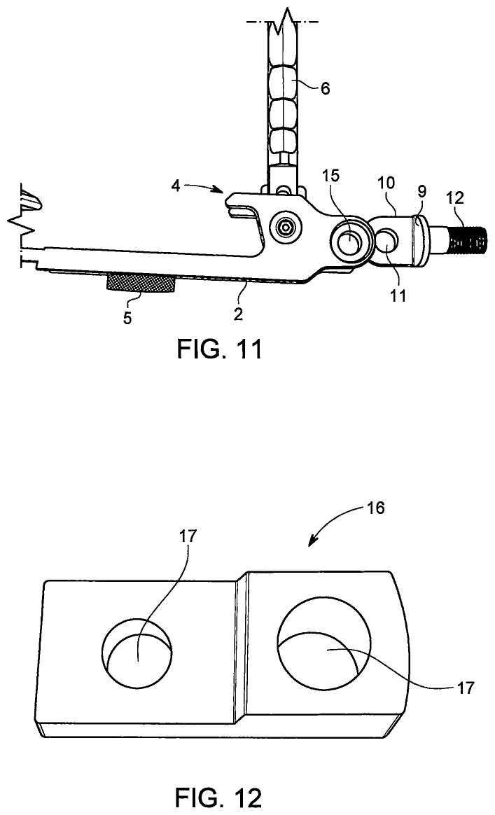

FIG. 10 illustrates the machined slot (13) and side walls (14) of the linear central support (2) of the mount of the invention. As shown in FIG. 11, the pad eye plate (7) is inserted into the machined slot (13) of the linear central support (2) of the present cell phone mount. The mounting hole (11) of the pad eye plate (7) is aligned with the mounting holes (15) of the side walls (14) of said machined slot (13) and a bolt, screw, pin or the like is inserted through the aligned holes securing the pad eye plate (7) to the linear central support (2). In one embodiment a bolt is inserted through the aligned holes and secured with a nut, in one embodiment a lock nut. Washers, in one embodiment nylon washers, can be used as needed throughout the mount of the invention.

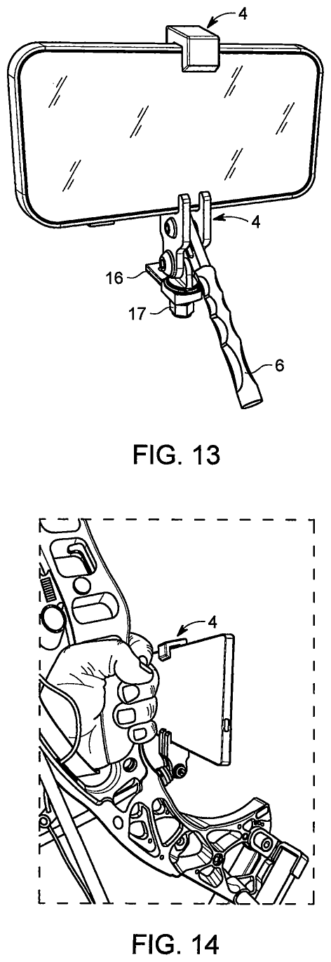

FIG. 12 shows a top view of the mounting plate (8) of the support base (3) of the mount of the invention while FIG. 13 shows a cell phone cradled in the mount of the invention.

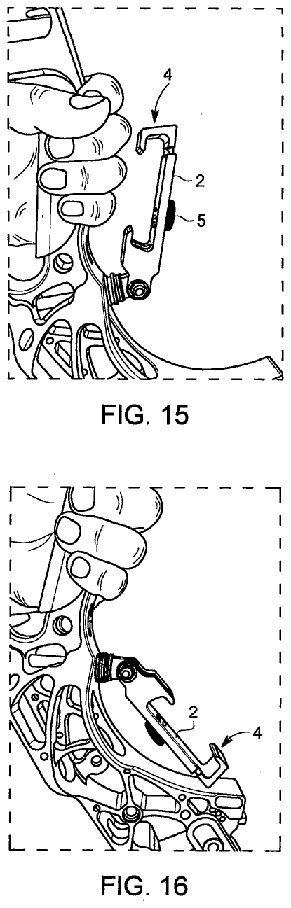

FIG. 14 shows a cell phone in the mount of the invention affixed to the riser of an archery bow; FIG. 15 shows the mount of the invention affixed to the riser of an archery bow in a folded-up position, and FIG. 16 shows the mount of the invention affixed to the riser of an archery bow in a folded-down position.

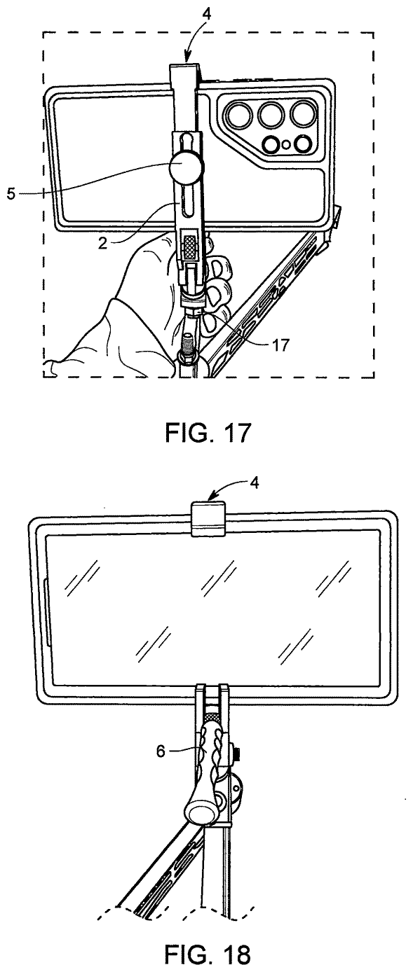

FIG. 17 shows the back view of a cell phone cradled in the mount of the invention affixed to a camera arm while FIG. 18 shows the front view of a cell phone cradled in the mount of the invention affixed to a camera arm.

The phone mount of the invention is extremely versatile and can be modified to be secured to any support structure including but not limited to a camera arm, archery bow, firearm, bicycle handlebar and the like. The mount of the invention can be constructed of almost any material that meets the strength and weight requirements of the particular use that is intended, including plastic, aluminum, aluminum alloys, steel, carbon fiber, fiberglass, and various resin, plastic and/or polymeric materials. In one embodiment the cell phone mount of the invention is fabricated from aluminum or aluminum alloy.

The cell phone mount of the invention can be quickly and easily modified to be attached to various support structures. For example, in embodiments where the phone mount of the invention is employed for with an archery bow, the mounting plate (8) of the support base (3) can be optionally removed, and the pad eye plate (7) can be fabricated with an elongated threaded appendage or bolt (12). The elongated threaded bolt can be of desired length and is sized to attach to the accessory mounting holes found on most archery bows. In one embodiment, the threaded bolt (12) is configured to thread into the accessory mounting hole of an archery bow riser typically used to attach a stabilizer to the archery bow.

The cell phone mount of the invention can be quickly and easily modified to be attached to various round, oval or square tubular structures including but not limited to bicycle, motorcycle and ATV/UTV handlebars or tubular frame elements of same, rifle or shotgun barrels, tubular elements of various treestands such as ladder stands or seat member of a two-piece climbing treestands. In such embodiments a circular, semi-circular or square clamp or bracket adapted or configured to attach to said tubular structure is attached to the mounting base of the present cell phone mount. Optionally, said clamps or brackets can be lined with a material, for example a soft elastomeric material, that cushions and soundproofs the interface between the clamp or bracket and the tubular structure.

The invention has been described herein using specific embodiments for purposes of illustration. It will be readily apparent to one of ordinary skill in the art that the principles of the invention can be embodied in other ways. Therefore, the invention should not be regarded as being limited in scope to the specific embodiments described herein,

I claim:

1. A cell phone mount configured to hold a cell phone, said mount comprising:
i) a linear central support comprising at least two hooked jaws configured to hold said cell phone wherein at least one of said laws is slidably adjustable to securely hold said cell phone in a vertical or horizontal position;
ii) optionally an adjustment arm for adjusting the aim point of the cell phone mount; and
iii) a support base attached to said linear central support, wherein said support base comprising a pad eye plate, said support base configured to secure said cell phone mount to a support structure, wherein said support base permits the rotational movement of said phone mount.

2. The cell phone mount of claim 1 wherein said support base is secured to said central support by fastening means, wherein said fastening means is selected from one or more of a screw, threaded bolt and nut, pin or stud.

3. The cell phone mount of claim 1 wherein said support base additionally comprises a mounting plate.

4. The cell phone mount of claim 3 wherein said pad eye plate comprises a horizontal base, a vertical wall perpendicular to upper side of said horizontal base and a threaded appendage or bolt on the bottom side of said horizontal base opposite the vertical wall.

5. The cell phone mount of claim 4 wherein the vertical wall of said pad eye plate comprises a mounting hole and said linear central support comprises a machined slot configured to receive the vertical wall of said pad eye plate, said machined slot having side walls with mounting holes configured to align with the mounting hole of the vertical wall of said pad eye plate, wherein said pad eye plate is secured to said linear central support by fastening means inserted through the aligned mounting holes of said side walls of the machined slot and the mounting hole of the vertical mounting plate.

6. The cell phone mount of claim 5 wherein said pad eye plate permits the rotational movement of said phone mount on the horizontal and vertical axis.

7. The cell phone mount of claim 3 wherein said mounting plate is perpendicular to the vertical plane of the linear central support, said mounting plate having mounting holes on both ends thereof, wherein one mounting hole is configured for attaching said cell phone mount to a support structure.

8. The cell phone mount of claim 7 wherein said mounting plate is secured to said center support by means of the threaded bolt or appendage of said pad eye plate.

9. The cell phone mount of claim 1 wherein said support structure is a camera arm, archery bow, firearm, bicycle, motorcycle or dirt bike handlebar, ATV/UTV handlebar or tubular support structure and the like.

10. A cell phone mount for affixing a cell phone to an archery bow, said mount comprising:
i. a linear central support comprising at least two hooked jaws configured to hold said cell phone wherein at least one of said laws is slidably adjustable to secure said cell phone;
ii. an adjustment arm for adjusting the aim point of the cell phone held in the cell phone mount; and
iii. a support base attached to said linear central support, said support base configured to secure said cell phone mount to a support structure, wherein said support base permits the rotational movement of said phone mount around both the vertical and horizontal axis, said support base comprising a pad eye plate.

11. The cell phone mount of claim 10 wherein said pad eye plate comprises a horizontal base, a vertical wall perpendicular to upper side of said horizontal base and an elongated threaded appendage or bolt on the bottom side of said horizontal base opposite the vertical wall, wherein said elongated appendage or bolt is threaded and configured to attach to an accessory mounting hole of said archery bow.

12. The cell phone mount of claim 11 wherein the vertical wall of said pad eye plate comprises a mounting hole and said linear central support comprises a machined slot configured to receive the vertical wall of said pad eye plate, said machined slot having side walls with mounting holes configured to align with the mounting hole of the vertical wall of said pad eye plate, wherein said pad eye plate is secured to said central support by fastening means inserted through the aligned mounting holes of said side walls of the machined slot and the mounting hole of the vertical wall of said pad eye plate.

13. The cell phone mount of claim 10 wherein said support base additionally comprises a mounting plate.

14. The cell phone mount of claim 13 wherein said mounting plate is perpendicular to the vertical plane of the linear central support, said mounting plate having mounting holes on both ends thereof, wherein one mounting hole is configured for attaching said cell phone mount to a support structure.

15. The cell phone mount of claim 14 wherein said mounting plate is secured to said center support by means of the threaded bolt or appendage of said pad eye plate.

16. The cell phone mount of claim 11 wherein the elongated threaded appendage or bolt of said pad eye plate is configured to thread into the accessory mounting hole of an archery bow riser used to attach a stabilizer to said bow.

17. The cell phone mount of claim 10 which comprises a circular, semi-circular or square clamp or bracket attached to the support base of said mount, wherein said clamp or bracket is configured to attach to a rounded, oval or square tubular support structure.

18. The cell phone mount of claim 17 wherein said tubular support structure is selected from bicycle, motorcycle, or motorbike handlebars, tree stand frame element, or the handlebar or frame element of an ATV, UTV or go-cart.
